(19) United States
(12) Patent Application Publication
(10) Pub. No.: US 2002/0146986 A1
(43) Pub. Date: Oct. 10, 2002

(54) Mobile telephone hand-free receiver

(76) Inventor: Den-Tsai Su, Taipei Hsien (TW)

Correspondence Address: Keith Kline, PRO-TECHTOR INTERNATIONAL SERVICES, 20775 Norada Court, Saratoga, CA, 95070-3018, US

(21) Appl. No.: 09/835,718

(22) Filed: Apr. 10, 2001

(51) Int. Cl. H04B 1/38

(52) U.S. Cl. 455/90; 455/575; 455/569

(57) ABSTRACT

The present invention relates to a mobile telephone hand-free receiver, wherein the battery box of the mobile telephone is changed to have the function of a hand-free receiver. The battery box consists of a battery back cover including a control circuit board, a horn, and a microphone, and a lower base snapped on the lower portion of the battery back cover. The lower base is formed with a connector that can be inserted into the insertion hole of the bottom of the mobile telephone body for supplying the signal of the mobile telephone body to the lower base and to the hand-free receiver control circuit board, thereby forming a battery back cover having a function of a hand-free receiver.

### BACKGROUND OF THE INVENTION

1. Field of the Invention

The present invention relates to a mobile telephone hand-free receiver, and more particularly to a mobile telephone hand-free receiver, wherein the battery box of the mobile telephone is changed to have the function of a hand-free receiver.

2. Description of the Related Art

An ordinary mobile telephone (or cellular phone) includes various configurations, and the volume of the mobile telephone becomes much smaller so as to satisfy the requirements of the consumers. However, the conventional mobile telephone does not have the function of a hand-free receiver, thereby greatly limiting the versatility of the mobile telephone.

### SUMMARY OF THE INVENTION

The primary objective of the present invention is to provide a mobile telephone hand-free receiver, wherein the mobile telephone only needs to replace the battery back cover to have the function of a hand-free receiver, without having replace the mobile telephone, thereby efficiently preventing consumption.

Another objective of the present invention is to provide a mobile telephone hand-free receiver, wherein the battery box of the mobile telephone is changed to have the function of a hand-free receiver.

A further objective of the present invention is to provide a mobile telephone hand-free receiver, wherein the battery box consists of a battery back cover including a control circuit board, a horn, and a microphone, and a lower base snapped on the lower portion of the battery back cover. The lower base is formed with a connector that can be inserted into the insertion hole of the bottom of the mobile telephone body for supplying the signal of the mobile telephone body to the lower base and to the hand-free receiver control circuit board, thereby forming a battery back cover having a function of a hand-free receiver.

In accordance with the present invention, there is provided a mobile telephone hand-free receiver, comprising:

a battery back cover;

a hand-free receiver control circuit board, provided with a horn amplification circuit and a microphone amplification circuit, the hand-free receiver control circuit board mounted at an inner face of the battery back cover;

a lower base, snapped on a lower portion of the battery back cover, the lower base formed with a first connector that can be inserted into an insertion hole of a bottom of a mobile telephone body, and a second connector connected to the hand-free receiver control circuit board for supplying a signal of the mobile telephone body to the lower base and to the hand-free receiver control circuit board, thereby forming a battery back cover having a function of a hand-free receiver.

The hand-free receiver control circuit board has a surface provided with pole elastic plates which directly contact with power connecting points of a battery. The power connecting points of the battery are connected to a battery circuit board for transferring electric power of a positive plate and a negative plate to the pole elastic plates of the hand-free receiver control circuit board. The inner face of the battery back cover is provided with a horn and a microphone which are connected to the hand-free receiver control circuit board. The lower base includes a connecting circuit board for transferring a signal of the mobile telephone body to the hand-free receiver control circuit board on the battery back cover. The first connector that can be inserted into the insertion hole of the bottom of the mobile telephone body includes an audio signal connector and a power connector. The battery back cover and the lower base are snapped with each other by snap holes and mating tenons.

Further benefits and advantages of the present invention will become apparent after a careful reading of the detailed description with appropriate reference to the accompanying drawings.

### BRIEF DESCRIPTION OF THE DRAWINGS

FIG. 1 is a partially perspective view of a mobile telephone hand-free receiver in accordance with the present invention;

FIG. 2 is a perspective view of a mobile telephone hand-free receiver in accordance with the present invention;

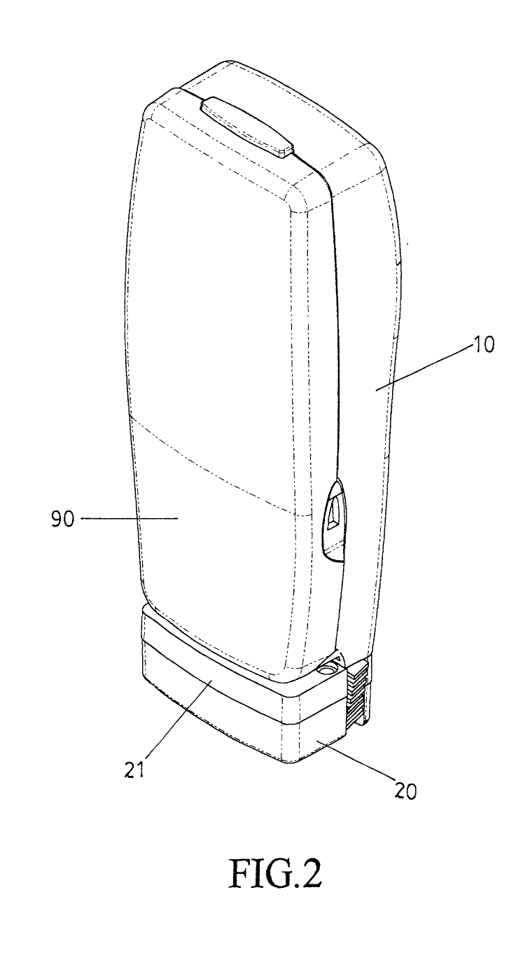

FIG. 3 is an exploded perspective view of the mobile telephone hand-free receiver as shown in FIG. 2;

FIG. 4 is a perspective view of a battery of the mobile telephone hand-free receiver in accordance with the present invention;

FIG. 5 is a partially exploded perspective view of the mobile telephone hand-free receiver as shown in FIG. 2;

FIG. 6 is a partially exploded perspective view of the mobile telephone hand-free receiver as shown in FIG. 2;

FIG. 7 is a partially exploded perspective view of the mobile telephone hand-free receiver as shown in FIG. 2;

FIG. 8 is a circuit diagram of the mobile telephone hand-free receiver as shown in FIG. 2;

FIG. 9 is a circuit diagram of the mobile telephone hand-free receiver as shown in FIG. 2;

FIG. 10 is a circuit diagram of the mobile telephone hand-free receiver as shown in FIG. 2; and

FIG. 11 is a circuit diagram of the mobile telephone hand-free receiver as shown in FIG. 2.

### DETAILED DESCRIPTION OF THE INVENTION

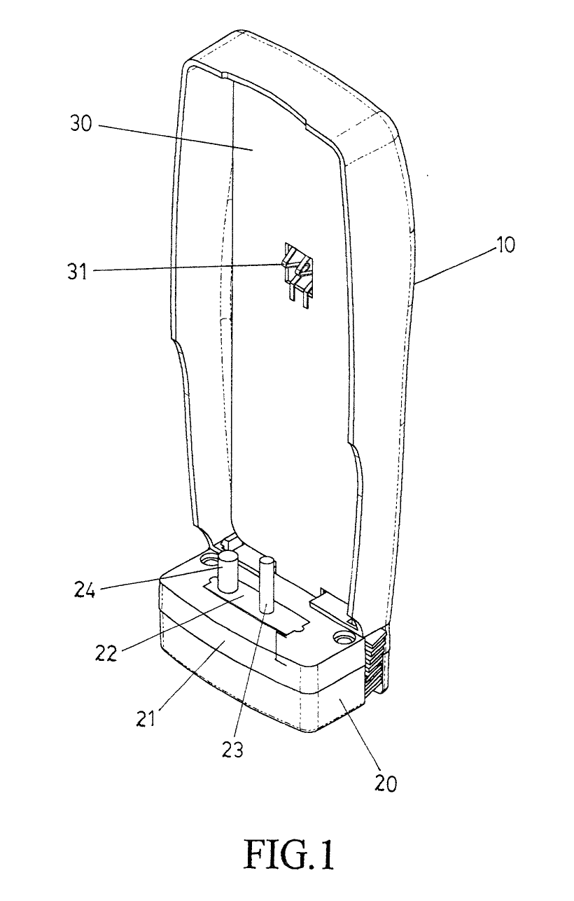

The mobile telephone (or cellular phone) hand-free receiver of the present invention is achieved by changing the structure of the battery back cover. Referring to FIG. 1, a mobile telephone hand-free receiver in accordance with the present invention comprises a battery back cover 10, a control circuit board 30 containing a hand-free receiver circuit, and a lower base 20 snapped on the bottom of the battery back cover 10. The base cover 21 above the lower base 20 is provided with an audio signal connector 23 and a power connector 24 which may be inserted into the insertion holes of the bottom of the mobile telephone body 90, such that the electric power and the signals of the mobile telephone body 90 can be transferred to the lower base 20 and the battery back cover 10, thereby forming a circuit connection.

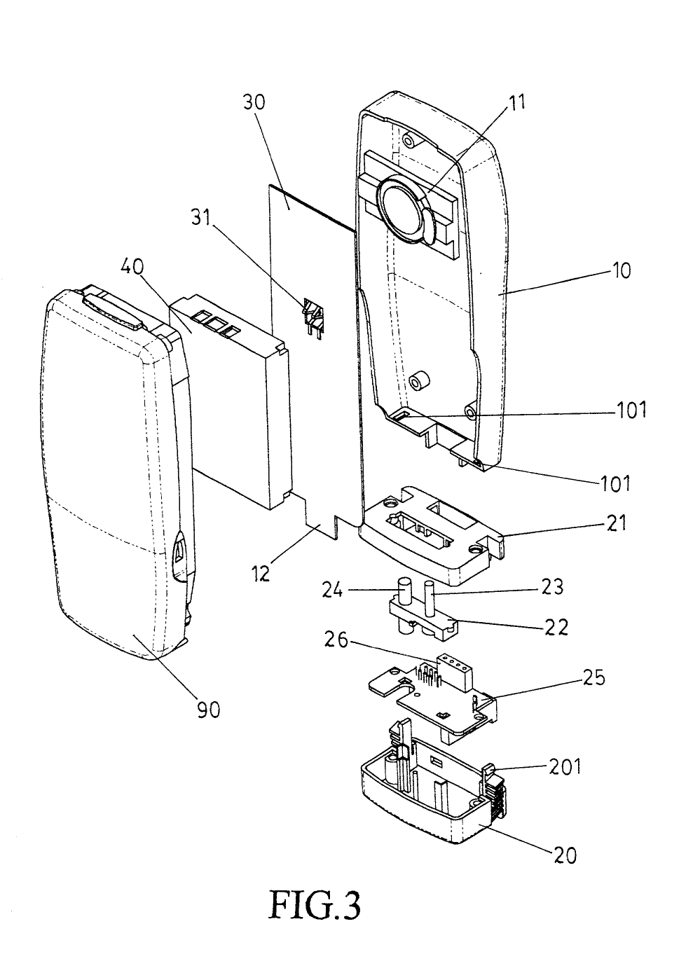

As shown in FIG. 3, the inner wall of the battery back cover 10 is serially provided with a horn 11 and a hand-free receiver control circuit board 30. The pole elastic plates 31 on the surface of the hand-free receiver control circuit board 30 are in contact with the poles of the wall face of the battery 40, s thereby forming a power supply circuit which may supply the required electric power to the hand-free receiver control circuit board 30. The bottom of the hand-free receiver control circuit board 30 is formed with a signal connector 12 connected with the lower base 20. The two sides of the bottom of the battery back cover 10 are formed with snap holes 101 snapped with the lower base 20. The two sides of the lower base 20 are formed with tenons 201 snapped with the snap holes 101. The top of the lower base 20 is serially combined with a connecting circuit board 25 having a signal connector 26, and a connector 22 having an audio signal connector 23 and a power connector 24. The lower base 20 is secured with the base cover 21, thereby forming the assembled state as shown in FIG. 1.

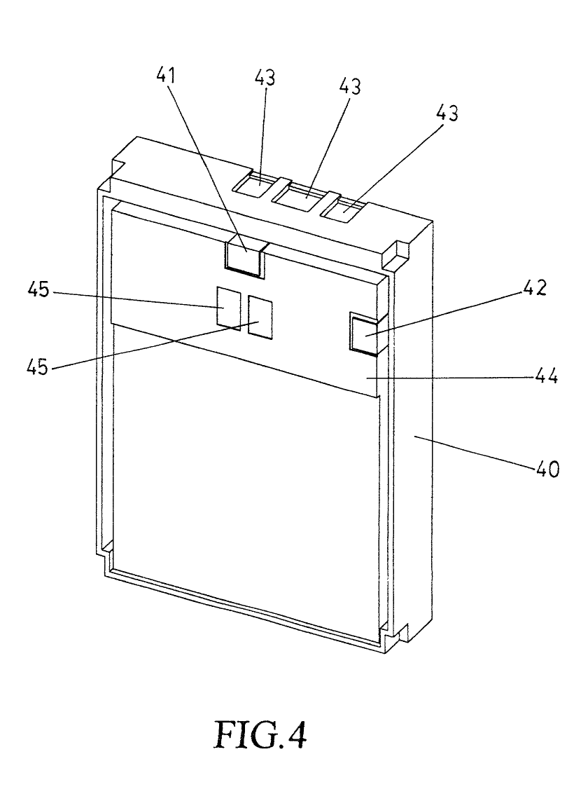

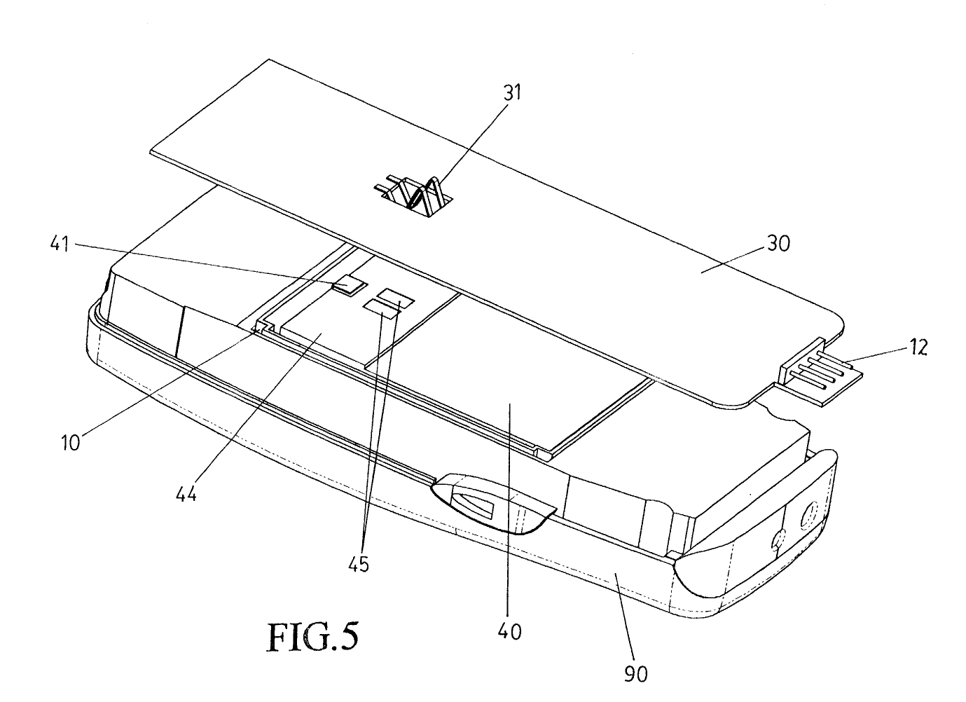

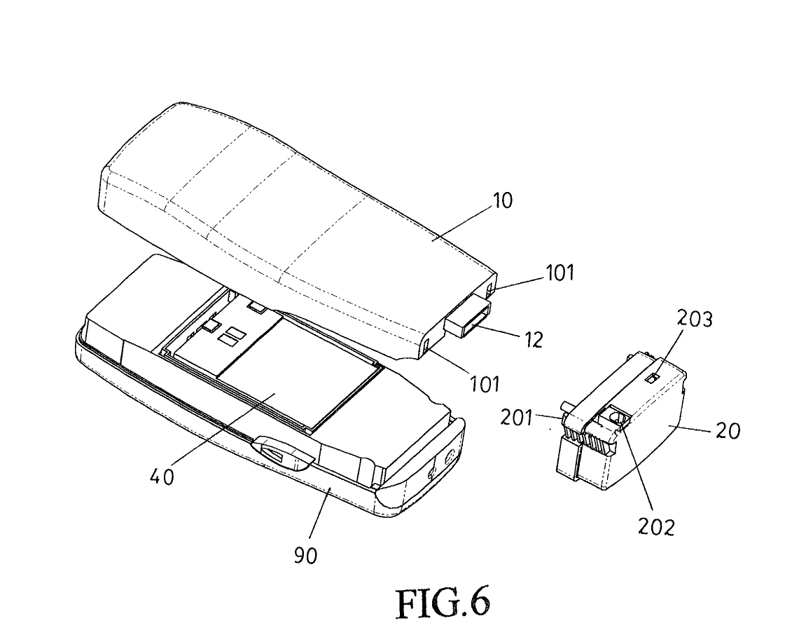

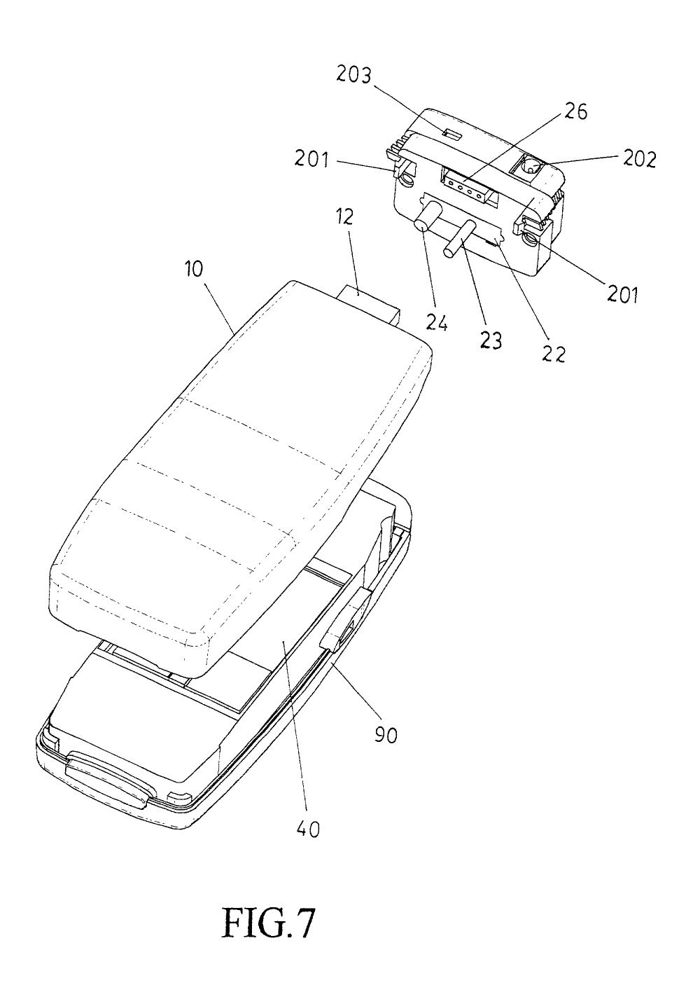

As shown in FIG. 4, the battery 40 includes power supply connecting points 43 for supplying the electric power to the mobile telephone, and has one side whose surface is provided with positive and negative poles 41 and 42, and is additionally provided with a battery circuit board 44 for transferring the electric power of the positive and negative poles 41 and 42 to the two power connecting points 45 at the central position of the circuit board 44. Thus, as shown in FIG. 5, the electric power of the battery 40 is transmitted to the hand-free receiver control circuit board 30 through the two pole elastic plates 31 that are in contact with each other. Then, as shown in FIGS. 6 and 7, the battery 40 and the hand-free receiver control circuit board 30 are combined with the battery back cover 10 which is snapped with the lower base 20 which allows insertion of the mobile telephone body 90, so that the mobile telephone may provide the function of a hand-free receiver. One side of the lower base 20 is provided with a charge insertion hole 202 for charging the mobile telephone body 90, and a hand-free receiver switch 203 for controlling the function of the hand-free receiver.

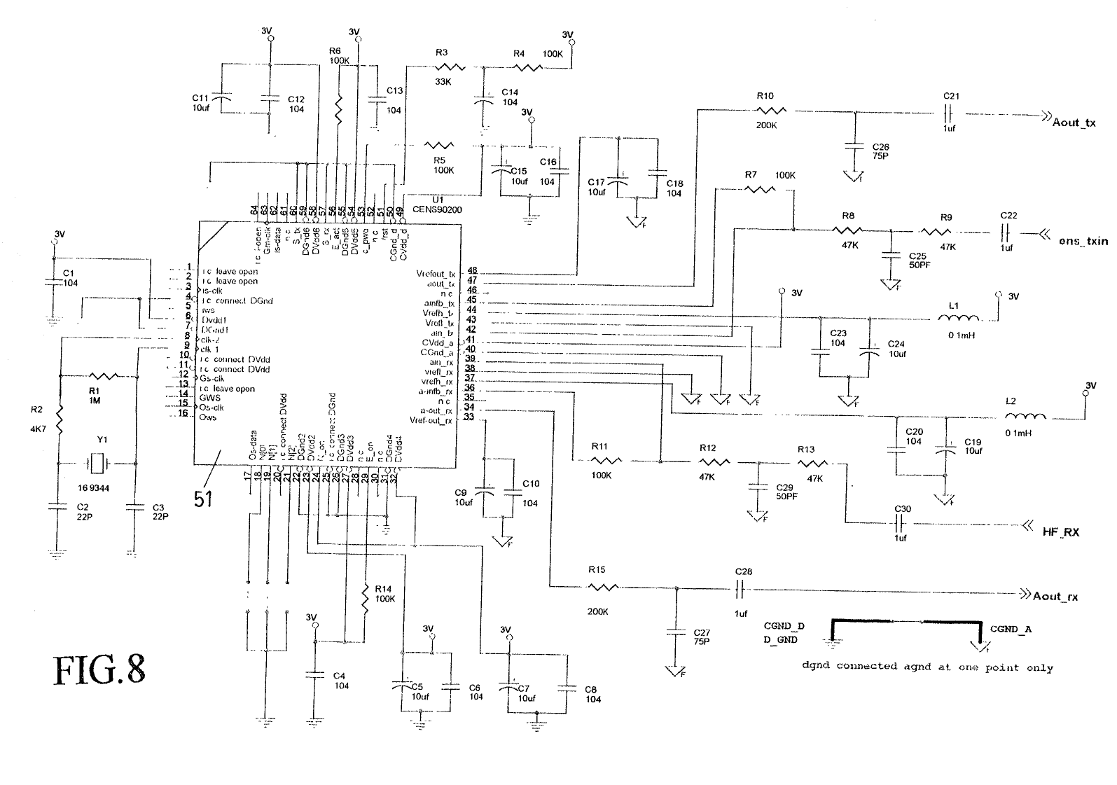

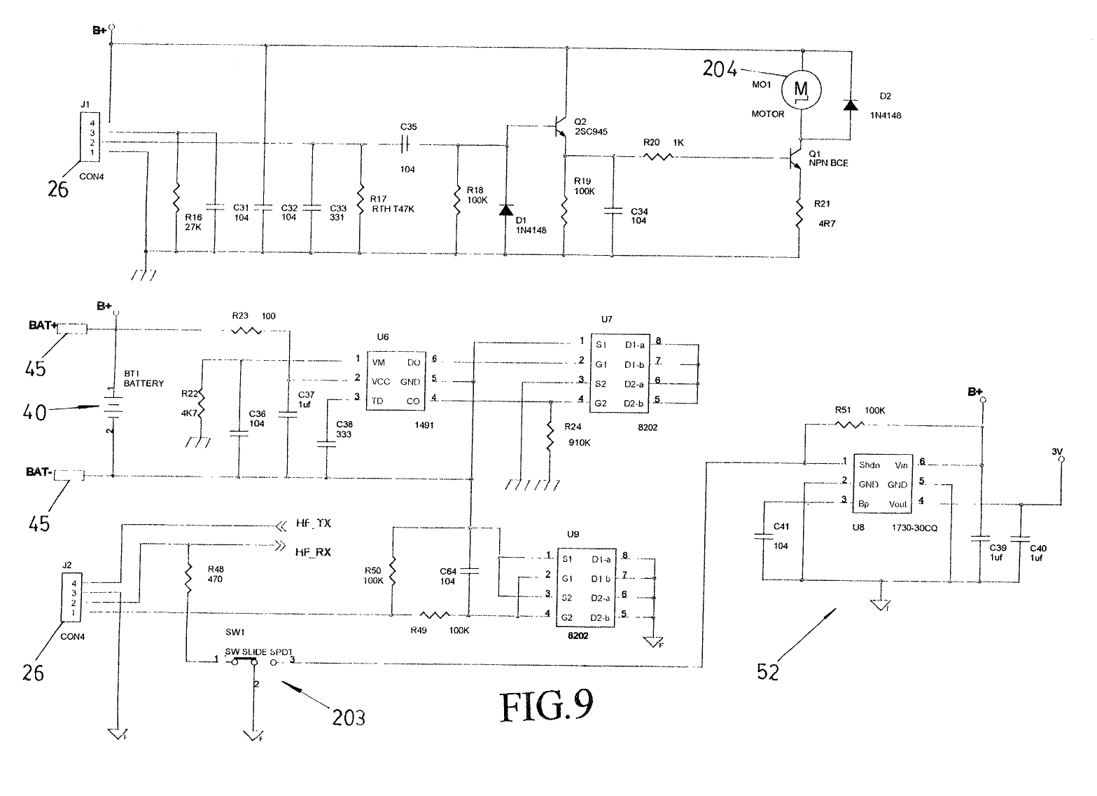

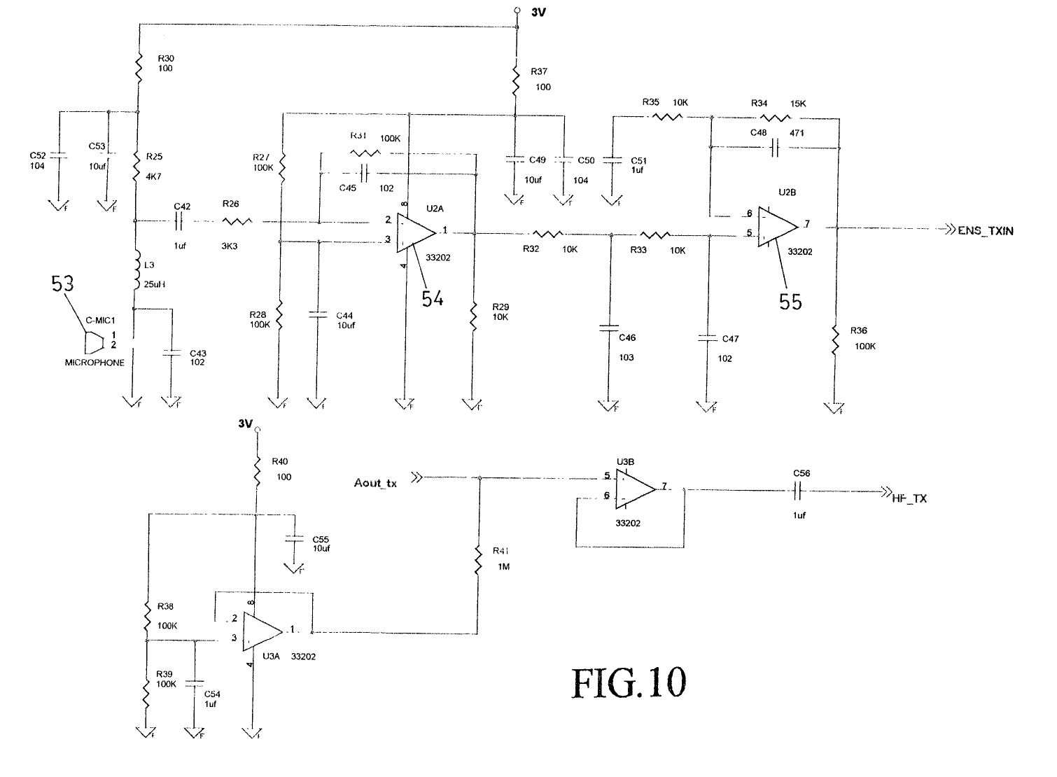

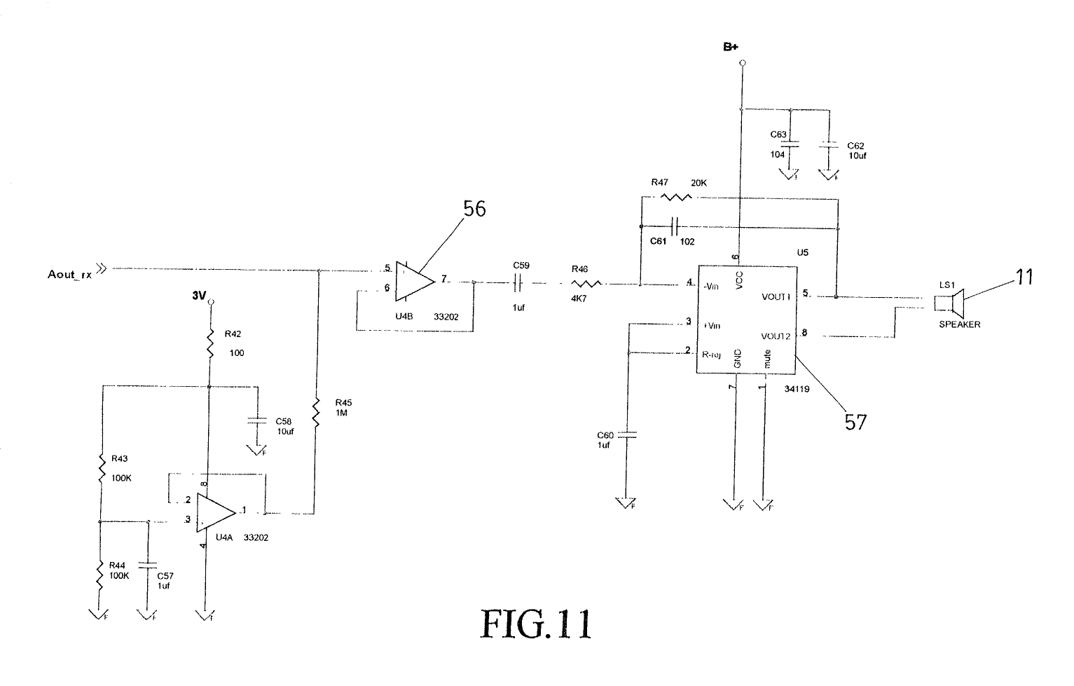

Referring to FIG. 8, a microprocessor 51 serves as the control center. FIG. 9 shows a steady voltage circuit 52 that is connected to the battery 40, and a hand-free receiver switch 203 connected to the signal connector 26. FIGS. 10 and 11 respectively show an audio amplification circuit (which consists of an amplifier 56 and a power amplifier 57) that is connected to the horn 56, and two operation amplifiers 54 and 55 that are connected to the microphone 53, thereby providing the function of audio signal input.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A mobile telephone hand-free receiver, comprising:
a battery back cover;
a hand-free receiver control circuit board, provided with a horn amplification circuit and a microphone amplification circuit, said hand-free receiver control circuit board mounted at an inner face of said battery back cover;
a lower base, snapped on a lower portion of said battery back cover, said lower base formed with a first connector that can be inserted into an insertion hole of a bottom of a mobile telephone body, and a second connector connected to said hand-free receiver control circuit board for supplying a signal of said mobile telephone body to said lower base and to said hand-free receiver control circuit board, thereby forming a battery back cover having a function of a hand-free receiver.

2. The mobile telephone hand-free receiver in accordance with claim 1, wherein said hand-free receiver control circuit board has a surface provided with pole elastic plates which directly contact with power connecting points of a battery.

3. The mobile telephone hand-free receiver in accordance with claim 2, wherein said power connecting points of said battery are connected to a battery circuit board for transferring electric power of a positive plate and a negative plate to said pole elastic plates of said hand-free receiver control circuit board.

4. The mobile telephone hand-free receiver in accordance with claim 1, wherein said inner face of said battery back cover is provided with a horn and a microphone which are connected to said hand-free receiver control circuit board.

5. The mobile telephone hand-free receiver in accordance with claim 1, wherein said lower base includes a connecting circuit board for transferring a signal of said mobile telephone body to said hand-free receiver control circuit board on said battery back cover.

6. The mobile telephone hand-free receiver in accordance with claim 1, wherein said first connector that can be inserted into said insertion hole of said bottom of said mobile telephone body includes an audio signal connector and a power connector.

7. The mobile telephone hand-free receiver in accordance with claim 1, wherein said battery back cover and said lower base are snapped with each other by snap holes and mating tenons.
